(19) United States
(12) Patent Application Publication
(10) Pub. No.: US 2024/0281811 A1
(43) Pub. Date: Aug. 22, 2024

(54) SYSTEM AND METHOD FOR BIOMETRIC PAYMENT

(71) Applicant: Garrick H. Meikle, SR., Englewood, NJ (US)

(72) Inventor: Garrick H. Meikle, SR., Englewood, NJ (US)

(21) Appl. No.: 18/648,330

(22) Filed: Apr. 26, 2024

Related U.S. Application Data
(63) Continuation-in-part of application No. 17/645,960, filed on Dec. 23, 2021, now abandoned.
(60) Provisional application No. 62/976,697, filed on Feb. 14, 2020.

(51) Int. Cl. G06Q 20/40; G06Q 20/36

(52) U.S. Cl. CPC G06Q 20/40145; G06Q 20/3674

(57) ABSTRACT

The system and methods disclosed provide a platform system, including software, and a backend system to conduct financial transactions, particularly biometric payments. The biometric payment platform system distinctly leverages biometric technology, such as facial recognition, to automatically verify the user's identity, access a digital asset, namely a digital wallet, that is specific to the user, and proceed with the payment (or other financial transaction). The platform also enables users, and vendors/business, to perform other financial transactions related to their digital asset, including transferring funds, withdrawing funds, and depositing funds. The platform provides convenient and secure financial transactions, without the user having to remember passwords, carry physical cards (e.g., debit card, credit card, etc.) or wallets, or even carry their own smartphone.

### RELATED APPLICATIONS

This is a Continuation-In-Part application of application Ser. No. 17/645,960 filed Dec. 23, 2021 which claims priority to U.S. provisional application No. 62/976,697 filed Feb. 14, 2020.

It is intended that each of the referenced applications may be applicable to the concepts and embodiments disclosed herein, even if such concepts and embodiments are disclosed in the referenced applications with different limitations and configurations and described using different examples and terminology.

The disclosures of the prior applications are hereby incorporated by reference herein in their entirety.

### FIELD OF DISCLOSURE

The present disclosure generally relates to methods and systems for electronic payment, particularly a wireless communication-based platform that facilitates financial transactions electronically and by leveraging biometric identification for users, such as facial recognition.

### BACKGROUND OF THE DISCLOSURE

Digital wallets, also referred to as e-wallets, mobile wallets, and virtual wallets, are a form of electronic payment systems, that allow individuals to store and manage their digital assets, such as money, credit and debit card information, loyalty points, and other types of assets. For example, a digital wallet can be accessed through a smartphone app, computer program, or a web-based platform. The primary benefit of using a digital wallet is convenience. It eliminates the need for individuals to carry physical cards or cash, and allows them to store all of their digital assets in a single, secure place. Digital wallets also offer additional features, such as the ability to pay for purchases with a smartphone, automatic coupon reward redemption, and the ability to send and receive money from other people.

To use a digital wallet, individuals typically need to link their credit or debit cards to the wallet, which they can then use to make purchases or pay bills. Some digital wallets also allow users to deposit money directly into the wallet, which can then be used to make purchases. Some digital wallets also support multiple types of digital assets, such as cryptocurrencies, which can be stored and managed within the wallet.

While many digital wallets offer benefits, they also come with risks. For example, digital wallets can be vulnerable to hacking and data breaches, which lead to the theft of financial information or digital assets. To mitigate these risks, it is important for individuals to choose a secure digital wallet and to best practices for protecting their personal and financial information. Accordingly, there is a long felt but unmet need in the art for technology which can address one or more of the drawbacks of presently existing digital wallets.

### BRIEF OVERVIEW

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

Additional aspects of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are and explanatory only and are not restrictive of the disclosure, as claimed.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates an example of a communication system in which embodiments disclosed herein may be implemented for providing a biometric payment platform system, according to one or more embodiments shown and described herein.

FIG. 2 illustrates an example architecture for the biometric payment platform system shown in FIG. 1, according to one or more embodiments shown and described herein.

FIG. 3 depicts an example of a method for implementing a biometric payment process, according to one or more embodiments shown and described herein.

FIG. 4 depicts an example of a computer system that may be used in implementing the biometric payment platform system, according to one or more embodiments shown and described herein.

### DETAILED DESCRIPTION OF THE DISCLOSURE

The present disclosure includes many aspects and features. Moreover, while many aspects and features relate to, and are described in, the context of a wireless platform providing biometric payment transactions, embodiments of the present disclosure are not limited to use only in this context. The present disclosure can be understood more readily by reference to the following detailed description of the disclosure and the Examples included therein.

Before the present articles, systems, apparatuses, and/or methods are disclosed and described, it is to be understood that they are not limited to specific methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

### A. Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “an opening” can include two or more openings.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Disclosed are the components to be used to manufacture the disclosed apparatuses, systems, and articles of the disclosure as well as the apparatuses themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and apparatuses of the disclosure. Thus, if there are a variety of additional steps that can be performed it is understood that each of these additional steps can be performed with any specific aspect or combination of aspects of the methods of the disclosure.

It is understood that the apparatuses and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

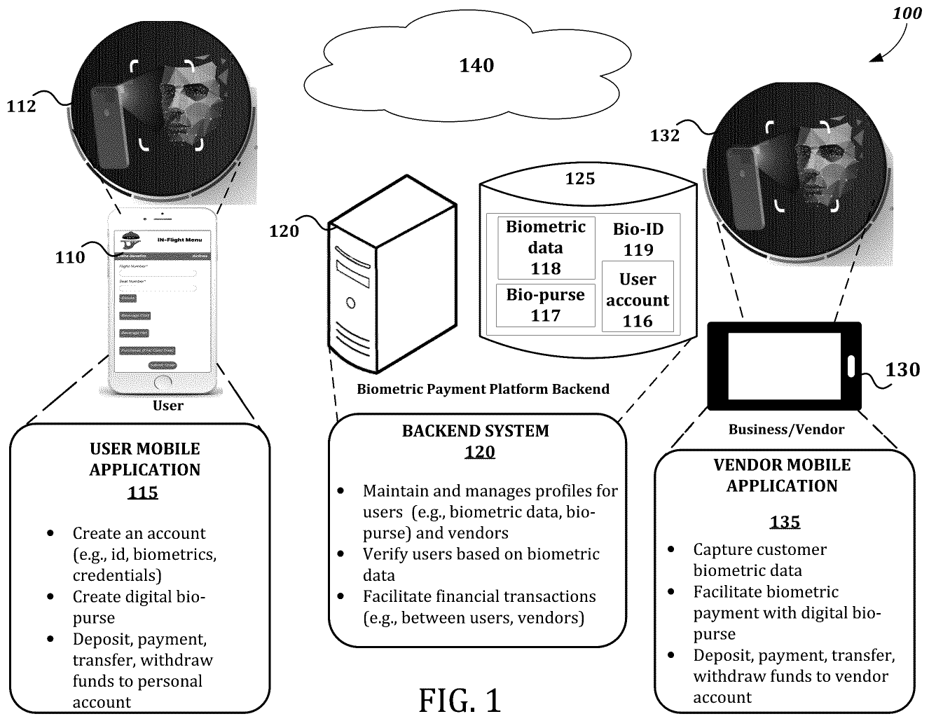

With reference now to the drawings, and in particular FIG. 1 through FIG. 27 thereof, examples of the wireless platform for providing a biometric payment platform system and the principles and concepts thereof will be described.

The system and methods disclosed herein can be described as a hardware and/or software platform system that is based on wireless communications, including computer software applications (apps), biometric identification and/or authorization technology and a backend system, which can be used to provide financial transactions that are performed electronically and securely. Thus, the disclosed embodiment provides a technology platform that efficiently and securely manages an end-to-end payment transaction process (e.g., transfer of funds, direct payment) in a manner that is cardless and cashless.

In an embodiment, the biometric payment platform system supports hardware, software, and biometric technology that can be accessed on a mobile computing device, and software applications (e.g., mobile “apps”) that can be installed on a mobile computing device. The end user software, particularly a user mobile app, that is supported by the biometric payment platform system may be employed by users that are conducting electronic-based financial transactions, for example setting up a digital wallet that is directly linked to the user's biometrics. The user mobile app for the biometric payment platform system allows users of the system access a plurality of features, including but limited to: registering an account to the platform using biometric information, referred to herein as a bio-identity (bio-id); utilizing their established bio-identity to create a digital wallet for payment, referred to herein as a bio-purse; and employing the bio-purse for electronic financial transactions, such as a payment ay vendor locations and funds transfer to other users, where the financial transactions are conducted from the bio-purse upon successful biometric identity verification using their established bio-identity, without requiring the use of a card (e.g., debit or credit card), cash, or even the user's mobile device. The user mobile device of the biometric payment platform system, as disclosed herein, can implement additional features related to digital wallets and financial transactions, as will be described herein.

In an embodiment, the biometric payment platform supports hardware, software, and biometric technology that can be accessed on a mobile computing device, and software applications (e.g., mobile “apps”) that can be installed on a mobile computing device employed businesses and/vendors. The end user software, particularly a vendor mobile app, that is supported by the biometric payment platform system may be employed by businesses and/or vendors that are conducting electronic-based financial transactions that are typically related to receiving payments for goods/services, for example conducting a financial charge of a user (e.g., receiving a payment). The mobile vendor app for the biometric payment platform system allows end users of the system, such as businesses and/or vendors, to access a plurality of features, including but not limited to: capturing a user's biometric information, such as facial biometrics, at a point-of-sale (POS) device; performing verification of the user's bio-identity and/or bio-purse on the system using the captured biometric information; and accepting user payment (e.g., issuing a financial charge) via the bio-purse corresponding to the verified user, wherein the funds for payment are received from the bio-purse, and without requiring the use of a card (e.g., debit or credit card), cash, or even the user's mobile device. The vendor mobile device of the biometric payment platform system, as disclosed herein, can implement additional features related to digital wallets and financial transactions, as will be described herein.

In an embodiment, the biometric payment platform system includes a backend system that that provides various features necessary to properly support secure and efficient end-to-end electronic financial transactions by leveraging biometric technology, such as facial recognition.

The back-end system can include software and data storage/management systems (e.g., database) supported by the biometric payment platform system to enable functions such as biometric verification; account registration and/or maintenance (e.g., bio-identity and bio-purse); and the like that are necessary to facilitate the completion of an electronic-based financial transaction, such as a payment. The backend for the biometric payment platform system supports a plurality of features, including but not limited to: supporting communication between the core components; maintaining a database of bio-identity profiles (e.g., biometric information for a registered user, personal information, login credentials, passcode, etc.), and bio-purse data (e.g., linked bank accounts, balance, transaction history, etc.) to allow for payments; supporting biometric technology, such as facial recognition analysis, in order to conducted biometric verifications; and the like. The backend of the biometric payment platform system, as disclosed herein, can implement additional features related to digital wallets and financial transactions, as will be described herein. Also, according to the embodiments, the biometric payment platform system leverages wireless communications, such as Internet connectivity, in order to support the interactive communication between elements of the platform, such as electronically submitting/receiving payments; and communicating biometric information.

The disclosed embodiments are directed to a biometric payment platform system 100, which leverages biometric technology to facilitate electronic financial transactions. For purposes of discussion the biometric payment platform system and techniques, such as the system of FIG. 1, are described with respect to facial recognition, but it should be understood that the embodiments disclosed herein are not intended to be limiting and can be implementing using other forms of biometric technology or mechanisms that enable automated recognition of individuals by means of unique physical characteristics (e.g., for the purposes of security), including but not limited to: facial, finger-print, retinal, iris, palm/hand or finger vein patterns, voice, and the like.

The disclosed embodiments are directed to a biometric payment platform system 100, which leverages biometric recognition to automate other actions that may be related to security and/or verifying a person's identity, including but not limited to: automatically unlocking doors; automatically accessing entryways; automatically unlocking safes; and automatically opening cabinets.

Generally, the biometric payment platform system 100 described herein employs a type of biometric authentication technology, for instance facial recognition technology, to confirm a person's identity and authorize financial transactions. For example, when a registered user of the system 100 enters a convenience store, for example, they can scan their face at a mobile device 130 having imaging capabilities (camera or depth sensor) that is employed by the business at their point-of-sale (POS), in order to capture their face which is linked to their specific digital bio-purse 117, where the bio-purse 117 is ultimately used as the form of payment. Thus, the system 100 distinctly leverages biometric technology, such as facial recognition, to verify the user's identity, access the digital bio-purse 117 (e.g., digital wallet) specifically corresponding to the user, and proceed with the payment (or other financial transaction). This type of biometric payment, which is implemented by the biometric payment platform system realizes several advantages over current payment systems, as it provides a convenient and secure way to make payments without having to remember passwords, carry physical cards (e.g., debit card, credit card, etc.) or wallets, or even carry the user's own smartphone. In other words, as long as the user is physically present themselves, the appropriate biometric information can be captured, such as scanning their face, in order to submit a payment via their personal digital bio-purse 117. Furthermore, the system 100 can also eliminate the need for physical contact, such as handling and/or exchanging cash or cards, making it a more hygienic option in the wake of the COVID-19 pandemic. Accordingly, the disclosed embodiments provide an efficient, convenient, secure, and technologically advanced system 100 that enables a form of biometric payment.

Referring now to FIG. 1, an example of a communication environment in which embodiments of the biometric payment platform system 100, disclosed herein, may be implemented. The biometric payment platform system 110 provides several features that specifically leverage biometric technology, such as facial recognition, in a manner that provides enhanced security, increased efficiency, and increased convenience to aspects of electronic financial transactions, such as payments via a digital wallet, that is not currently available. As alluded to above, the biometric payment platform system 110 is distinctly designed to provide a technology platform that uses biometric verification in order to securely, efficiently, and interactively manage the end-to-end financial transaction processes, including payments, transfers, and withdrawals.

The biometric payment platform system 110 can be a network-based platform (e.g., Internet) that is accessed and interacted with by a plurality of distributed users. Typically, users must complete a sign-up process with the biometric payment platform system 110, which can include creating an account in order to access the features provided by the system 110. For example, users of the system 110 can enable end user devices, such as laptop computers, smartphones, and the like to wirelessly connect to a communication network 140, such as the Internet, and thereby connect to the biometric payment platform system 110. FIG. 1 illustrates a mobile computer device 130, shown as a smartphone, that can be used by user, where user is interested in creating a digital wallet (e.g., linked to their registered account), herein referred to as a bio-purse 117, that can be stored and maintained by the biometric payment platform system 110, and later accessed in manner that allows the user to conduct various electronic financial transactions, such as payments when they are the customer at a business, and using the funds that are available in their individual digital wallet.

Referring back to the example of FIG. 1, the mobile computer devices 110, 130 can establish wireless connections to the biometric payment platform system 100 via the communication network 140, such as the Internet. Thus, the biometric payment platform system 100 can include a web-based platform that can be accessed remotely by a software, such as applications, depicted as user mobile application 125 and vendor mobile application 135, that is installed on and/or accessible via the mobile computer devices 120, 130 respectively, in order to control aspects of the biometric payment process, such as creating a digital bio-purse 117 for the user, capture biometric data (e.g., facial images) to initiate payment, and the like. FIG. 1 shows that a user can have a mobile computer device 110 to download and install the user mobile appl 115 thereon. Additionally, FIG. 1 shows that a vendor can have a mobile computer device 130 to download and install the vendor mobile app 135 thereon.

The communication network 140 can facilitate access and communication to global Wide Area Networks (WAN), such as the Internet, and supports any number of wireless communication protocols such as: WIFI, BLUETOOTH, ZIGBEE, cellular based protocols, and the like. It should be appreciated that the mobile computer devices 110, 130 may be implemented as various numbers of mobile and/or portable computing devices that are suitable for portable usage, such as a smartphone, a tablet, a laptop, or a wearable device such as a smartwatch, or other computer device, such as a desktop computer.

Accordingly, the mobile computer devices 110, 130 can utilize software applications, namely the user mobile app 115 and the vendor mobile app 135 respectively, that implement a graphical user interface (GUI) and user experience (UX) environments and features of the biometric payment platform system 100 to allow users to access, view, and interact with its features over the distributed communication network 140 (e.g., Internet).

According to the embodiments, the user mobile app 115 is an element of the system's 110 platform that supports the functionalities that are associated with an individual user (as opposed to a business or vendor) interactions for an electronic financial transaction. FIG. 1 depicts the user mobile application 115 as supporting features that include, but are not limited to: creating an account 116, which includes submitting biometric data (e.g., facial images), entering personal data (e.g., name, age), entering credentials (e.g., login name, password, two-factor authentication passcode); creating, accessing, and managing a digital bio-purse 117; and performing financial transactions associated with the bio-purse, such as depositing funds, submitting payment (to vendor) of funds, transfer funds to another user, withdraw of funds, and the like.

A user can utilize the user mobile app 115 on their mobile computer device 110 to register (or sign-up) to the biometric payment platform system 110 to establish an account and utilize the system's 100 features. For example, a user can become a registered user for the system 100 by creating an account 116, and submitting (via the user mobile app 115) information that is pertinent to identifying, authorization, authentication, tracking, and verification of that user, such as personal information (e.g., name, age, gender, address, etc.), creating login credential (e.g., login username, password), and the like. In some embodiments, the information for creating the user's account 116 is entered via the user mobile app 115. Then the user's account information, submitted via the user mobile app 115, can be forwarded to the backend system 120 in order to be stored and maintained by the database 125 as a record (e.g., with other accounts, identities, and bio-profiles of other users on the system 100). FIG. 1 illustrates the user's account 116 being located at the backend system 120, particularly being stored at the database 125.

In response to the user setting up an account 116, the biometric payment platform system 100 can then create the bio-purse 117, a form of digital wallet or e-wallet for the user, that is maintained by the system 100. The user can link a payment method, such as a bank account (e.g., routing number, account number, etc.), credit card, debit card and the like, which can be used to add funds to their bio-purse 117 to support financial transactions. The user can access, manage, and/or interact with their bio-purse 117, for instance to add a payment method, via the user mobile app 115. In other words, once a user registers to the biometric payment platform system 100, the system 100 the registered user is tied to their own bio-purse 117 that they can then use for electronic financial transactions. According to the embodiments, the bio-purse 117 has a plurality of functions, including but not limited to: being used as a payment system (ability to pay for purchases); being a form of a digital asset; being used to send and receive money from other people; and the like. The bio-purse 117 can be accessed through the user mobile app 115 by the user's smartphone app, a computer program, or a web-based platform. Generally, the data and functionality for the bio-purse 117 is supported by the backend system 120, and can be interacted with by the various other elements of the system 100, including the user mobile app 115 and the vendor mobile app 135. For example, when the user is shopping at the business having the vendor mobile 135, the user can access their bio-purse (e.g., retrieved by the backend system 120) for a payment. However, the disclosed bio-purse 117 is distinct from conventional digital wallets, e-wallets, and other digital assets, in that the bio-purse 117 can be accessed, and ultimately used for financial transactions, simply with the user's own biological individual identity, or biometric data, namely their face. The biometric payment platform system 100 can accomplish this distinct functionality (e.g., biometric payment), because the system 100 links the registered user's account 116, their bio-purse 117, and ultimately their identity, to the user's unique biometric data, which is also registered by the user and stored on the system 100.

Furthermore, the user can employ the user mobile app 115 to submit their uniquely identifiable biometric data 118 that is also used by the system 100 to identify and/or verify the identity of the user. In some cases, the user can employ the various capabilities of their mobile computer device 110 (e.g., camera, image capture, scanning, voice recording, etc.) to capture biometric data 118. FIG. 1 depicts an example of the user entering biometric data 118 for facial recognition. The user is employing the front-facing camera of their mobile computer device 110, namely a smartphone, to take one or more pictures of their face and submit the captured facial images (via the user mobile app 115) as biometric data 118 to the backend system 120 for storage in its database 125. In some embodiments, the user mobile app 115 supports facial recognition software 112 that performs analysis functions, such as measuring facial features and dimensions in images, to extract the unique biological markers that identifies or confirms a person's identity using their face. Thus, in some embodiments, the user mobile app 115 is configured to forward already processed biometric data 118 to the backend system 120, which is in a proper format to perform biometric identification (e.g., biometric data 118 that has been prepared by the facial recognition software 112). Alternatively, the user mobile app 115 can send data the data itself, such as digital camera images, to the backend system 120, where the backend 120 is configured to perform the further analysis necessary to extract the useful biometric data 118. Although facial recognition (e.g., facial images) biometric data is described in reference of FIG. 1, the user can also submit other forms of biometric information, related to the user's unique physical characteristics, which enables automated recognition of the user. For example, types of data that can be added (via the user mobile app 115) to the user's profile as biometric data 118 includes, but is not limited to: facial data, finger-print data, retinal data, iris data, palm/hand or finger vein pattern data, voice data, and the like.

As a result of the user registering their unique biometric data 118 to the system 100, the user's specific account 116, bio-purse 117, and ultimately their identity is linked directly to the user's biometrics, shown as the biometric data 118 (e.g., facial images), within the system 100. As seen in FIG. 1, the biometric payment platform system 100 establishes this relationship between the user's identity, biometrics, and finances (e.g., digital wallet) namely linking their account 116, bio-purse 117, and biometric data 118 to a single record that corresponds collectively and specifically to the user, which is referred to herein as a bio-id profile 119. In other words, the bio-id profile 119 serves as a biometric record of the user that can be used throughout the system 100, for instance having a record of the user's biological individual identity, including their face, fingerprint, etc. Consequently, the biometric payment platform system 100 can receive data comprising the user's corresponding bio-id profile 119, and then use this data as a reference to identify, verify, and retrieve the user's profile on the system 100. For example, the biometric payment platform system 100 can simply receive an image of the user's face, and automatically find their entire bio-id profile 119, including accessing their bio-purse 117, which can subsequently be used in a payment transaction.

The backend system 120 of the biometric payment platform system 100 can be implemented as computer system(s), such as server(s), that implements functionality and features that support computerized/automated biometric-based electronic financial transactions, such as biometric payment, as disclosed herein. The backend system 120 is configured to handle communication, transfer of data, and interactions (including financial transactions), between the various elements of the biometric payment platform system 100, such as communications to/from the user mobile app 115, a user's bio-purse 117, and the vendor mobile app 135. FIG. 1 depicts the backend system 120 as implementing several functions of the system 100, including but not limited to: storing, maintaining, and managing the plurality of bio-profiles for users on the system 100; verifying users based on biometric data; and facilitating the various types of financial transactions that can be conducted thru the system 100, such as transferring funds to/from a user's bio-purse, adding funds to a user's bio-purse, account balances, submitting funds from bio-purse as payment, and the like. The backend system 120 is configured to store, maintain, and manage accounts for vendors and/or business that are registered to the system 100, in a similar manner, which also allows the vendors to conduct financial transactions via the system 100.

A key feature of the biometric payment platform system 100 is facilitating a digital payment between a user and a business/vendor, which is initiated (or authorized) simply by the user presenting their biometric identity, without the need of presenting any other physical forms of payment/identification, such as a debit card, cash, or smartphone. Thus, an important function of the backend system 120 is storing, maintaining, and managing the plurality of bio-id profiles, such as the bio-id profile 119, where each bio-id profile respectively corresponds to each registered user on the system 100 in a manner that links their biological identity (e.g., biometric data) to their stored identity (e.g., account) and financial assets (e.g., digital wallet, bio-purse) that are on the system 100. The backend system 120 has the biometric identification capabilities, which enables the backend system 120 to receive biometric data, such as an image of a person's face, and automatically parse the profiles of registered users stored on the database 125 to determine if it matches any of the biometric identities (e.g., stored bio-id profiles including each user's facial images/features) on the system 100. If there is a successful match to a stored biometric identity, namely a stored bio-id profile 119, then the backend system 100 can identify a particular user to which the biometric identify corresponds, verify that the user is a registered user on the system 100 (e.g., authorizing a financial transaction), and subsequently retrieve the corresponding account data, particularly the user's bio-purse which can be used for payment. Accordingly, the backend system 120 is configured with the hardware, software, code, algorithms, and other components necessary to support these functionalities, including: application programming interfaces (APIs), facial recognition software, biometric recognition software, electronic messaging software (e.g., SMS, e-mail), financial transaction software (e.g., STRIP), and the like. Thus, the backend system 120 implements the functionality of employing a user's biometric identity (e.g., face, fingerprint, etc.) to automatically identify the particular user on the system 100, and subsequently access, and retrieve their other registered data, including their bio-purse 119 to conduct a financial transaction securely and efficiently.

The vendor mobile app 135 is an element of the system's 110 platform that supports interactions for tasks that are associated with a business and/or vendor in an electronic financial transactional process, such as charging a user for a specified amount of money (e.g., purchase prince), and receiving funds from a user as payment. According to some embodiments, the vendor mobile app 135 can be employed by a vendor to register to the system 100 and create a vendor account (e.g., store, maintain, and manage by the backend system 120), in a manner similar to users as describe above, which enables the vendors and/or business that are registered to the system 100 to conduct several financial transactions via the system 100. FIG. 1 depicts the vendor mobile app 135 as being downloaded and installed on a mobile computer device 130 that is employed at the vendor location, such as a tablet computing device which is being used by the business as a POS device. The vendor mobile app 135 can be implemented on other types of computer devices that may be employed by a business (not shown in FIG. 1), such as a computerized register or kiosk at brick-and-mortar store location, a smartphone at a “pop-up” or mobile store location (e.g., food truck), and the like. In some embodiments, the vendors are registered by a system administration (e.g., via an administration dashboard), where a password for the vendor account is assigned to the vendor by administration after creating account. Registered vendors can use the vendor mobile app 135 for charging user for payment (e.g., biometric payment), and communicating with other elements of the biometric platform system 100.

Also, FIG. 1 depicts the vendor mobile app 135 as supporting several features that include, but are not limited to: capturing customer biometric data; facilitating biometric payment for a purchase using the user's digital bio-purse; and conducting several financial transactions including, adding funds to the vendor account, transferring funds to a user, and requesting system administration for a withdrawal of funds from the vendor account.

FIG. 1 illustrates an example use of the vendor mobile app 135 for conducting a biometric payment via the system 100. A customer making a purchase at a biometric payment enabled business, the customer can go to the mobile computer device 130, shown as a tablet computer, which is functioning as a POS device for the business. When the customer is standing at the vendor's device 130, the capabilities of the mobile computer device 130 can be employed to capture the customer's biometric data. For example, the customer can position themselves such that the mobile computer device's 130 camera can capture digital images of the customer's face, which are obtained by the vendor mobile app 135 to be ultimately communicated to the system 100 as the customer's biological identity. FIG. 1 illustrates the vendor mobile app 135 as including facial recognition software 132, which enables the identifiable characteristics of the customer's face to be extract from the digital images, and communicated to the system 100. Although facial recognition (e.g., facial images) biometric data is described in reference of FIG. 1, the vendor mobile app 135 is configured to capture other forms of biometric information, related to the user's unique physical characteristics, which enables automated recognition of the user. For example, types of data that can be captured (e.g., using the appropriate hardware/software devices) via the vendor mobile app 135 as the customer's biometric identity includes, but is not limited to: facial data, finger-print data, retinal data, iris data, palm/hand or finger vein pattern data, voice data, and the like.

After capturing the customer's biometric data at the time of purchase, the backend system 120 can utilize this biometric data, such as facial images, in order to perform biometric identification of the customer, automatically identifying them, and verifying that the customer is indeed a registered user of the system 100 who owns an active bio-purse (e.g., based on all of the user's bio-id profiles that are stored on the system 100). In response to a successful verification by the backend system 120, the customer's bio-purse can be access by the vendor mobile app 135 and the funds thereon authorized to be used for payment. Referring back to the example, the vendor mobile app 135 captures images of the customer's face, which are then identified by the backend system 120 as biometrically matching (e.g., from facial recognition analysis) the face data in the bio-id profile 119 (e.g., same user of mobile computer device 110 and user mobile app 115). As a result of verifying the customer's identity on the system 100 simply from presenting their face, the vendor mobile app 135 can then automatically access the digital bio-purse 117 for that customer, and charge it for payment. In some embodiments, the vendor mobile app 135 may employ secondary security features, for example a two-factor authentication that requires the customer to enter a password to complete the transaction in order to further supplement the security of the system 100. Accordingly, the biometric payment platform system 100 realizes the advantages of leveraging biometrics in order to conduct financial transactions in a manner that is fast (e.g., eliminate time associated with counting cash, physically retrieving and swiping cards), secure (e.g., reduced potential of card mimicking, cash theft, and use of stolen cards), and convenient (e.g., user only needs their biological identify).

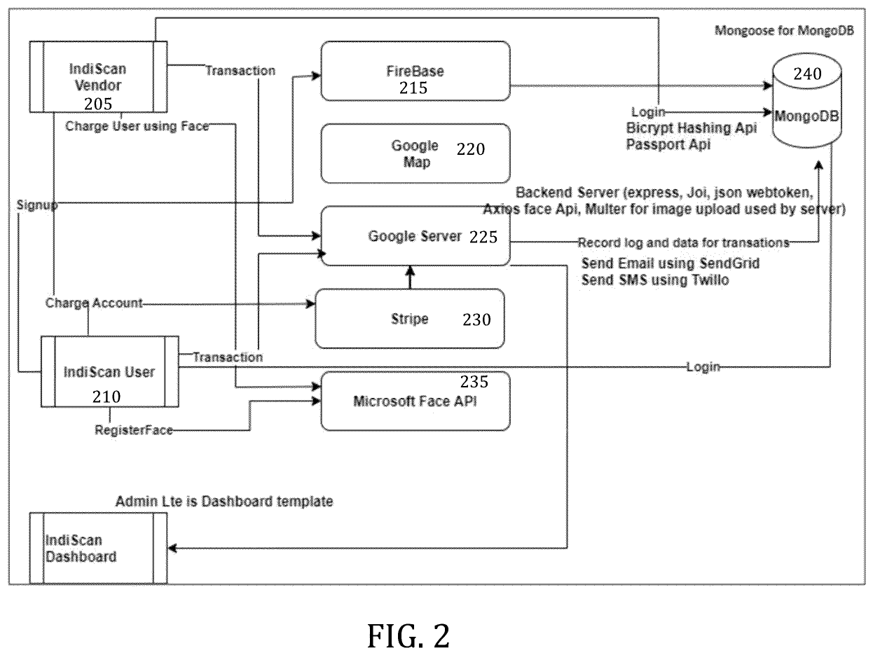

FIG. 2 illustrates an example architecture for the disclosed biometric payment platform system 200. Particularly, FIG. 2 shows the system 200 including a vendor component 205, a user component 210, and a dashboard component 215, which may be implemented as software applications described above in reference to FIG. 1. There are various workflows that can be implemented from each of the aforementioned components 205, 210, 215, which can respectively implement the various functions of the biometric payment platform and system.

FIG. 2 depicts the vendor component 205 executing a workflow for implementing a transaction. The workflow begins with the vendor 205 communicating with the server 225 (e.g., backend system), and then the database 240 in order to record log and data for the transactions. Another workflow implemented by the vendor 205 executes charging the user using their biometric identity (e.g., face), referred to herein also as biometric payment function. The vendor 205 communicates with the face API 235 (e.g., backend system). Yet another workflow implemented by the vendor 205 executes charging an account. Here, the vendor 205 communicates with the user component 210. Additionally, the vendor 205 executes a workflow to perform a login to the system 200, where the vendor communicates with the database 240.

Also, FIG. 2 depicts the user component 210 executing a workflow for implementing a user's signup process, or registering with the system 200. The workflow begins with the user 205 communicating with a Backend-as-a-Service (BaaS) component 215 (e.g., backend system), and then the database 240. Another workflow implemented by the user 205 executes a transaction, where the user 210 communicates with the server 240 for login. Yet another workflow implemented by the user executes registering the user's biometric data, such as their face. Here, the user 210 communicates with the face API 235 (e.g., backend system).

In addition, FIG. 2 depicts the dashboard component 215 executing a workflow where the server 220 (e.g., backend system) communicates with it. This workflow can facilitate some electronic communication and messaging features for the system 200, such as sending e-mail and Short Message Service (SMS) messages.

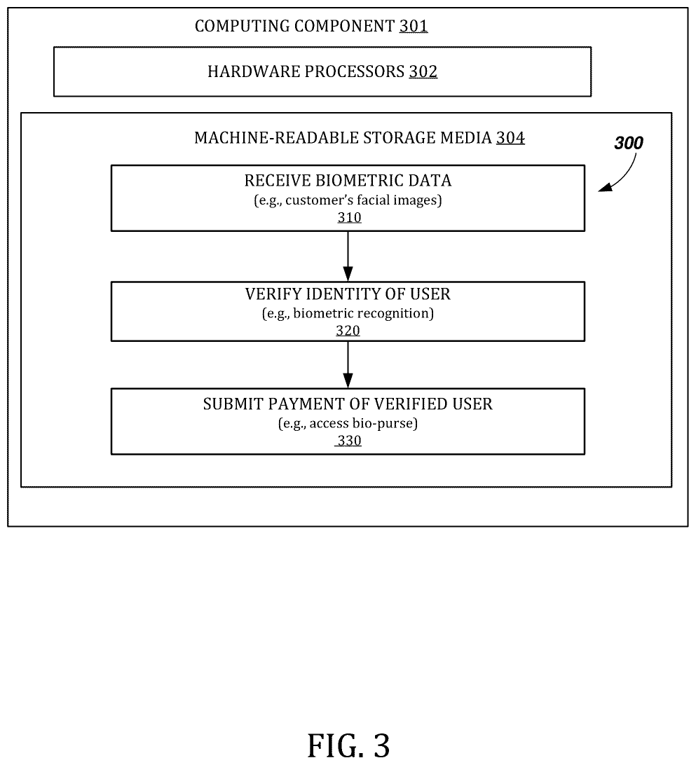

FIG. 3 depicts an example method 300 for implementing the biometric payment features of the biometric payment platform system, as disclosed herein. FIG. 3 illustrates a flow chart of the method 300, showing it as a series of executable operations stored on a machine-readable storage medium 304 performed by hardware processors 302, which can be the main processor of a computing component 301. For example, the computing component 301 can be the backend system 300, described at least in reference to FIG. 1. In operation, hardware processors 302 execute the operations of method 300, thereby implementing the disclosed techniques. In the example, the method 300 begins at operation 310 where biometric data for a customer is received. As described herein, the process 300 allows the customer to simply present their biological identity, such their face, to be captured and subsequently initiate a payment. For example, the customer can be at a such as a kiosk, console, tablet, POS register, or other computer device that is enabled for biometric payment, and thus incorporate devices that have capabilities to capture, scan, or read biometric information from a human. In some embodiments, the biometrics data captured and received in operation 310 are digital images of the customer's face that were capture by a digital camera. In some embodiments, the biometrics data captured and received in operation 310 is the customer's fingerprint that was scanned/read by an optical scanner (or fingerprint scanner). For purposes of discussion, process 300 is described with respect to facial recognition, but it should be understood that the embodiments disclosed herein are not intended to be limiting and can be implementing using other forms of biometric technology or mechanisms. Thus, the biometric data received in operation 310 from the customer can be any type of data that enables automated recognition of individuals by means of unique physical characteristics (e.g., for the purposes of security), including but not limited to: facial, finger-print, retinal, iris, palm/hand or finger vein patterns, voice, and the like.

Next, at operation 320, the identity of the customer is automatically verified. According to the embodiments, various biometric recognition analyses can be applied to the received biometric data in order to verify the identity of the customer, and particularly whether the identified customer is an individual that is authorized to employ biometric payment (e.g., registered user of the biometric payment platform system, with active digital bio-purse) For example, operation 320 can involve performing facial recognition to verify that the facial profile/characteristics of the customer matches a known, or stored, facial profile which corresponds to an authorized user of biometric payment. In some cases, verifying the biometric identity of the customer (by applying a biometric recognition analysis to the received biometric data) also retrieves other data (e.g., bio-id profile) corresponding to the verified identity, such as that customer's name, and most importantly their digital bio-purse. As a result, verifying the identity of customer, in operation 310, automatically retrieves the digital assets of the customer, namely the customer's unique digital bio-purse, simply by the customer presenting their biological identity, such as their face or fingerprint.

The process 300 continues to operation 330 where payment is automatically submitted in order to complete the purchase. As alluded to above, previous operation 320 ultimately retrieves the digital bio-purse of the customer (based on the verified identity). Thus, in operation 330, this particular bio-purse for the customer is then accessed in a manner that enables any funds charged by the vendor for the purchase, to be submitted from the funds available on the customer's digital asset. That is, the customer's bio-purse is charged for the purchase, and uses the available funds to make the payment. In some embodiments, a two-factor authentication is required from the customer for the payment to be fully authorized and completed. Operation 330 can also include the transfer of the necessary financial information and digital funds, for example between the user's financial accounts and the vendors financial accounts, in order for the payment to be completed and the full end-to-end financial transactional process executed.

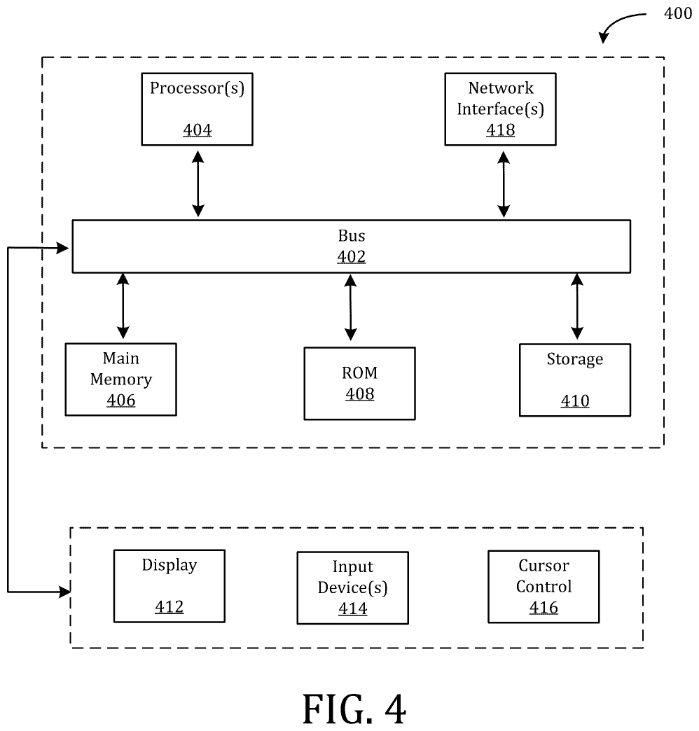

FIG. 4 depicts a block diagram of an example computer system 400 in which the disclosed aspects of the biometric payment platform system (shown in FIG. 1) may be implemented. Furthermore, it should be appreciated that although the various instructions are illustrated as being co-located within a single processing unit, there may be some implementations in which processor(s) includes multiple processing units, allowing one or more instructions may be executed remotely from the other instructions.

The computer system 400 includes a bus 402 or other communication mechanism for communicating information, one or more hardware processors 404 coupled with bus 412 for processing information. Hardware processor(s) 404 may be, for example, one or more general purpose microprocessors.

The computer system 400 also includes a main memory 406, such as a random-access memory (RAM), cache and/or other dynamic storage devices, coupled to bus 402 for storing information and instructions to be executed by processor 404. Main memory 406 also may be used for storing temporary variables or other intermediate information during execution of instructions to be executed by processor 404. Such instructions, when stored in storage media accessible to processor 404, render computer system 400 into a special-purpose machine that is customized to perform the operations specified in the instructions.

The computer system 400 further includes a read only memory (ROM) 408 or other static storage device coupled to bus 402 for storing static information and instructions for processor 404. A storage device 410, such as a magnetic disk, optical disk, or USB thumb drive (Flash drive), etc., is provided and coupled to bus 402 for storing information and instructions.

The computer system 400 may be coupled via bus 402 to a display 412, such as a liquid crystal display (LCD) (or touch screen), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. In some embodiments, the same direction information and command selections as cursor control may be implemented via receiving touches on a touch screen without a cursor.

The computing system 400 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Python, Ruby on Rails or NodeJS. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 400 may implement the techniques described herein using customized hard-wired logic, one or more ASICs or FPGAs, firmware and/or program logic which in combination with the computer system causes or programs computer system 2700 to be a special-purpose machine. According to one embodiment, the techniques herein are performed by computer system 400 in response to processor(s) 404 executing one or more sequences of one or more instructions contained in main memory 406. Such instructions may be read into main memory 406 from another storage medium, such as storage device 410. Execution of the sequences of instructions contained in main memory 406 causes processor(s) 404 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 410. Volatile media includes dynamic memory, such as main memory 406. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 402. Transmission media can also take the form of acoustic or light waves, such as those generated during radio-wave and infra-red data communications.

The computer system 400 also includes a communication interface 418 coupled to bus 402. Network interface 418 provides a two-way data communication coupling to one or more network links that are connected to one or more local networks. For example, communication interface 418 may be an integrated services digital network (ISDN) card, cable modem, satellite modem, or a modem to provide a data communication connection to a corresponding type of telephone line. As another example, network interface 418 may be a local area network (LAN) card to provide a data communication connection to a compatible LAN (or WAN component to communicate with a WAN). Wireless links may also be implemented. In any such implementation, network interface 418 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local networks and Internet both use electrical, electromagnetic or optical signals that carry digital data streams. The signals through the various networks and the signals on network link and through communication interface 418, which carry the digital data to and from computer system 410, are example forms of transmission media.

The computer system 400 can send messages and receive data, including program code, through the network(s), network link and communication interface 418. In the Internet example, a server might transmit a requested code for an application program through the Internet, the ISP, the local network and the communication interface 418.

The received code may be executed by processor 404 as it is received, and/or stored in storage device 410, or other non-volatile storage for later execution.

### Improved Authentication Methods

These methods showcase the potential for innovation in the field of biometric authentication, offering a range of possibilities for secure and convenient user verification for the biometric payment platform system. Here are other embodiments of various biometric authentication methods that could be particularly effective for payment authorization and preventing identity theft using the biometric payment platform system:

Multi-Factor Iris Recognition: Combining iris recognition with a secondary biometric factor, such as a fingerprint or facial recognition, can significantly enhance security for payment authorization. In one or more embodiments, the biometric payment platform system may use multi-factor iris recognition analysis for biometric authentication.

Dynamic Signature Verification: This method analyzes the way a person signs their name, including speed, pressure, and rhythm. It can be used for authorizing payments, especially in banking and legal transactions. In one or more embodiments, the biometric payment platform system may use dynamic signature verification analysis for biometric authentication.

Voiceprint Analysis: Voice biometrics can authenticate payments by analyzing unique vocal characteristics. This method is useful for phone-based payment systems and virtual assistants. In one or more embodiments, the biometric payment platform system may use voiceprint analysis for biometric authentication.

Fingerprint-Enabled Payment Cards: Payment cards with embedded fingerprint sensors can authenticate transactions at the point of sale, adding an extra layer of security to traditional card payments. In one or more embodiments, the biometric payment platform system may use fingerprint-enabled payment card analysis for biometric authentication.

Behavioral Biometrics: This includes analysis of user behavior such as typing patterns, mouse movements, and even browsing patterns, which can be used for continuous authentication during online payments. In one or more embodiments, the biometric payment platform system may use behavioral biometric analysis for biometric authentication.

Palm Vein Recognition: Palm vein patterns are unique and cannot be easily replicated, making them a secure method for authorizing high-value transactions. In one or more embodiments, the biometric payment platform system may use palm vein recognition analysis for biometric authentication.

Facial Recognition with Liveness Detection: Advanced facial recognition systems can detect liveness, ensuring that the payment is being authorized by a live person rather than a photograph or video. In one or more embodiments, the biometric payment platform system may use facial recognition analysis for biometric authentication.

Secure QR Codes with Biometric Encryption: QR codes for payment can be encrypted with biometric data, so that they can only be activated by the authorized user's biometric verification. In one or more embodiments, the biometric payment platform system may use secure QR codes with biometric encryption analysis for biometric authentication.

Capillary Pattern Recognition: Unique patterns in the capillaries under the skin can be used for biometric identification, providing a subtle yet secure method for payment authorization. In one or more embodiments, the biometric payment platform system may use capillary pattern recognition analysis for biometric authentication.

Electroencephalogram (EEG) Patterns: Though more futuristic, EEG patterns could be used to authenticate identity based on brainwave signals, offering a highly secure payment authorization method. In one or more embodiments, the biometric payment platform system may use EEG pattern analysis for biometric authentication.

Gait Analysis: Using sensors or video footage, a system could analyze an individual's unique walking pattern as a form of identification. This could be particularly useful in security-sensitive areas where hands-free access is preferred. In one or more embodiments, the biometric payment platform system may use gait analysis for biometric authentication.

Ear Shape Recognition: Just like fingerprints, every person's ear shape is unique. Special scanners could be developed to use this feature for personal identification, suitable for environments where individuals are likely to wear gloves or have dirty hands. In one or more embodiments, the biometric payment platform system may use ear shape recognition analysis for biometric authentication.

Heartbeat Identification: Everyone has a unique heartbeat pattern. Wearable devices or specialized sensors could authenticate identity based on an individual's electrocardiogram (ECG) signature. In one or more embodiments, the biometric payment platform system may use heartbeat identification analysis for biometric authentication.

Vein Pattern Recognition: Vein patterns, like fingerprints, are unique to each individual. Scanners that detect the pattern of veins in the hands or fingers could provide a secure method of identification. In one or more embodiments, the biometric payment platform system may use vein pattern recognition analysis for biometric authentication.

Scent Detection: Each person has a unique chemical scent. Sensitive olfactory sensors could potentially identify individuals based on their body odor, though this method would require overcoming significant practical challenges. In one or more embodiments, the biometric payment platform system may use scent detection analysis for biometric authentication.

Typing Dynamics: Individuals have unique typing patterns, including speed and rhythm. Software could analyze these patterns when typing on a keyboard to verify a user's identity. In one or more embodiments, the biometric payment platform system may use typing dynamics analysis for biometric authentication.

Cognitive Biometrics: This involves patterns in the way people think, solve problems, and react to stimuli. Advanced AI analyzes these cognitive patterns for identification purposes. In one or more embodiments, the biometric payment platform system may use cognitive biometrics analysis for biometric authentication.

Eye Movement Tracking: Eye tracking technology could be used to identify individuals based on their unique eye movement patterns, which could be particularly useful in virtual reality (VR) environments. In one or more embodiments, the biometric payment platform system may use eye movement tracking analysis for biometric authentication.

Lip Movement Recognition: Speech-related lip movements are unique to each person. Visual or sensor-based systems could authenticate individuals based on their lip movement patterns while speaking. In one or more embodiments, the biometric payment platform system may use lip movement recognition analysis for biometric authentication.

Nail Bed Microcirculation Patterns: The microcirculation patterns in nail beds are unique and could be used for identification through high-resolution imaging technology. In one or more embodiments, the biometric payment platform system may use nail bed microcirculation pattern analysis for biometric authentication.

These methods leverage unique biological and behavioral traits to ensure that payment transactions are secure and that the identity of the user is accurately verified, reducing the risk of fraud and identity theft.

### Other Embodiments

In one or more embodiments, the biometric payment platform system may be used for the following applications:

Pets/Animals Cataloging and Identification: The biometric payment platform system can be applied to the cataloging and identification of pets and animals using facial recognition technology. This improves the way pets are tracked and identified, providing a more reliable and efficient method than traditional tags or microchips.

EV Car Charging Locations: The biometric payment platform system could be used to facilitate the payment process at electric vehicle (EV) charging stations. By replacing cash transactions, the system would offer a seamless and secure method for users to pay for their charging services.

ATM Machine Access/Verification: The biometric payment platform system could also be applied to ATM machines, where facial recognition could replace the need for debit cards and PINs. This would enhance security and convenience for users by simplifying the authentication process.

Patient Identification in Medical Facilities: In hospital and medical facility locations, the biometric payment platform system could be used for patient identification, ensuring that medical records and treatments are accurately matched to the correct individual without the need for physical ID cards.

Amusement Park/Water Park Identification: The biometric payment platform system could be implemented in amusement parks and water parks for identification purposes and to enable cashless transactions. This would allow guests to access lockers, make purchases at concession stands, and enjoy other amenities without the need to carry cash or cards.

Movie Ticketing and Entry: The biometric payment platform system could transform the movie-going experience by replacing physical tickets with facial recognition entry systems. This would streamline the entry process and potentially reduce the chances of ticket fraud.

Event/Venue Ticketing and Entry: The biometric payment platform system could transform the event and venue experience by replacing physical tickets with facial recognition entry systems. This would streamline the entry process and potentially reduce the chances of ticket fraud.

These applications demonstrate the versatility and potential impact of the biometric payment platform system in various industries, enhancing security, convenience, and user experience.

In various implementations, operations that are performed “in response to” or “as a consequence of” another operation (e.g., a determination or an identification) are not performed if the prior operation is unsuccessful (e.g., if the determination was not performed). Operations that are performed “automatically” are operations that are performed without user intervention (e.g., intervening user input). Features in this document that are described with conditional language may describe implementations that are optional. In some examples, “transmitting” from a first device to a second device includes the first device placing data into a network for receipt by the second device, but may not include the second device receiving the data. Conversely, “receiving” from a first device may include receiving the data from a network, but may not include the first device transmitting the data.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computer processors, not only residing within a single machine, but deployed across a number of machines.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

### Aspects

The following disclose various Aspects of the present disclosure. The various Aspects are not to be construed as patent claims unless the language of the Aspect appears as a patent claim. The Aspects describe various non-limiting embodiments of the present disclosure.
Aspect 1. A system, comprising:
a processor;
a memory on which are stored machine-readable instructions that when executed by the processor, cause the processor to:
receive biometric data associated with a user, wherein the user is conducting a purchase;
in response to receiving the biometric data, automatically verify the identity of the user based on the received biometric data; and
automatically submit a payment using a digital asset corresponding to the verified identity user to complete the purchase.
Aspect 2. The system of claim 1, wherein the machine-readable instructions further cause the processor to:
apply a biometric analysis to the received biometric data to extract biometric profile of the user; and
determine whether the extracted biometric profile of the user matches a stored biometric profile, wherein the stored biometric profile indicates the verified identity of a user for biometric payment.
Aspect 3. The system of Aspect 2, wherein the machine-readable instructions further cause the processor to:
retrieve the digital asset corresponding to the verified identity of the user, wherein the stored biometric data and the digital asset are linked to a stored record for the verified identity.
Aspect 4. The system of Aspect 3, wherein the machine-readable instructions further cause the processor to:
charge the retrieved digital asset for funds of payment to complete the purchase.
Aspect 5. The system of Aspect 1, wherein the digital asset comprises a digital wallet.
Aspect 6. The system of Aspect 1, wherein the biometric data comprises facial images of the user.
Aspect 7. The system of Aspect 6, wherein the biometric recognition analysis comprises facial recognition.
Aspect 8. The system of Aspect 7, wherein the machine-readable instructions further cause the processor to:
capture the facial images of the user using a camera.
Aspect 9. The system of Aspect 8, wherein the camera is a component of a device associated with the location of the purchase.
Aspect 10. A computer platform system, comprising:
a communication network;
a mobile computer device communicatively coupled to the communication network and capturing biometric data associated with a user to transmit via the communication network, wherein the user is conducting a purchase at the mobile computer device; and
a server communicatively coupled to the communication network and receiving the biometric data associated with a user to automatically authorize a biometric payment to complete the purchase based on the received a biometric data.
Aspect 11. The system of Aspect 10, wherein the mobile computer device comprises a point-of-sale (POS) device of a business.
Aspect 12. The system of Aspect 11, wherein the biometric data comprises facial images of the user.
Aspect 13. The system of Aspect 11, wherein the mobile computer device comprises a camera to capture the facial images of the user.
Aspect 14. The system of Aspect 13, wherein the server automatically authorizes the biometric payment by verifying the identity of the user based on facial recognition, and retrieving a digital asset corresponding to the verified identity of the user.
Aspect 15. The system of Aspect 14, wherein funds from the digital asset are used to submit the biometric payment to complete the purchase.
Aspect 16. The system of Aspect 14, wherein the server verifies the identity of the user by determining whether the captured facial images of the user matches stored facial images, wherein the stored facial images indicate the verified identity of a user.
Aspect 17. The system of Aspect 15, further comprising a database maintaining the stored facial images, and the digital asset.
Aspect 18. The system of Aspect 16, wherein the database further maintains a record corresponding the facial images to the digital asset for the verified identity of the user.
Aspect 19. The system of Aspect 18, wherein the digital asset comprises a digital wallet.
Aspect 20. The system of Aspect 19, further comprising an additional mobile device associated with the user, wherein the stored facial images associated with the user are captured and transmitted to the server by the additional mobile device to create the record corresponding the facial images to the digital asset.

What is claimed is:

1. A system, comprising:
a processor;
a memory on which are stored machine-readable instructions that when executed by the processor, cause the processor to:
receive biometric data associated with a user, wherein the user is conducting a transaction;
in response to receiving the biometric data, automatically verify the identity of the user based on the received biometric data; and
automatically initiate a transaction using a digital asset corresponding to the verified identity of the user to complete the transaction.

2. The system of claim 1, wherein the machine-readable instructions further cause the processor to: apply a biometric analysis to the received biometric data to extract a biometric signature of the user; and determine whether the extracted biometric signature of the user matches a stored biometric signature, wherein the stored biometric signature indicates the verified identity of a user for biometric transactions.

3. The system of claim 2, wherein the machine-readable instructions further cause the processor to: retrieve the digital asset corresponding to the verified identity of the user, wherein the stored biometric data and the digital asset are linked to a stored profile for the verified identity.

4. The system of claim 3, wherein the machine-readable instructions further cause the processor to debit the retrieved digital asset for funds to complete the transaction.

5. The system of claim 1, wherein the digital asset includes a digital currency account.

6. The system of claim 1, wherein the biometric data includes a voiceprint of the user.

7. The system of claim 6, wherein the biometric recognition analysis includes voice recognition.

8. The system of claim 7, wherein the machine-readable instructions further cause the processor to: capture the voiceprint of the user using a microphone.

9. The system of claim 8, wherein the microphone is a component of a device located at the transaction site.

10. A computer platform system, comprising:
a communication network;
a mobile computing device communicatively coupled to the communication network and capturing biometric data associated with a user to transmit via the communication network,
wherein the user is conducting a transaction at the mobile computing device; and
a server communicatively coupled to the communication network and receiving the biometric data associated with a user to automatically authorize a biometric transaction to complete the transaction based on the received biometric data.

11. The system of claim 10, wherein the mobile computing device includes a handheld transaction device of a merchant.

12. The system of claim 11, wherein the biometric data includes a retinal scan of the user.

13. The system of claim 11, wherein the mobile computing device includes a scanner to capture the retinal scan of the user.

14. The system of claim 13, wherein the server automatically authorizes the biometric transaction by verifying the identity of the user based on retinal scanning, and retrieving a digital asset corresponding to the verified identity of the user.

15. The system of claim 14, wherein resources from the digital asset are allocated to submit the biometric transaction to complete the transaction.

16. The system of claim 14, wherein the server confirms the identity of the user by determining whether the captured retinal scan of the user matches stored retinal scans, wherein the stored retinal scans indicate the verified identity of a user.

17. The system of claim 15, further including a database maintaining the stored retinal scans, and the digital asset.

18. The system of claim 16, wherein the database further maintains a record associating the retinal scans with the digital asset for the verified identity of the user.

19. The system of claim 18, wherein the digital asset includes a blockchain-based wallet.

20. The system of claim 19, further comprising an additional security layer that utilizes cryptographic tokens for transaction verification.
